(19) United States
(12) Patent Application Publication
(10) Pub. No.: US 2006/0010036 A1
(43) Pub. Date: Jan. 12, 2006

(54) Customer-friendly website

(76) Inventor: Thomas W. Burry, College Park, MD (US)

Correspondence Address: William S. Ramsey, 5253 Even Star Place, Columbia, MD, 21044, US

(21) Appl. No.: 11/227,560

(22) Filed: Sep. 15, 2005

Related U.S. Application Data
(63) Continuation-in-part of application No. 11/041,397, filed on Jan. 24, 2005.
Application No. 11/041,397 is a continuation-in-part of application No. 10/638,765, filed on Aug. 11, 2003.

(51) Int. Cl. G06Q 30/00

(52) U.S. Cl. 705/14

(57) ABSTRACT

Exemplary embodiments are customer-friendly websites and methods of using websites which contain advertisements by suppliers and distributors of customized promotional products, both of which are members of a limited constituency. The websites of some embodiments are for use by customers of the distributors, who typically are retailers. Advertisements of the suppliers feature product information and promotional offerings. The suppliers are identified only by identification symbols such as numbers or bear a statement that the supplier will sell only through distributors. Advertisements of the distributors, who distribute items manufactured by the suppliers, feature accessible information allowing contact between the distributors and customers, and may include promotional offers. In use of some embodiments, the customer peruses promotional product offerings by suppliers and identifies items of interest. The customer then contacts a distributor, which may be in the customer's geographic region, and orders the custom additions for the promotional products, and pays for the items to the distributor. The distributor communicates the customization information to the supplier and pays the supplier for the items. The supplier customizes the items and ships them to the customer.

### CROSS-REFERENCE(S)

This is a continuation-in-part application which claims priority to Ser. No. 11/041,397, filed Jan. 24, 2005; PCT/US04/25824, filed Aug. 10, 2004; and Ser. No. 10/638,765, filed Aug. 22, 2003, all pending and all incorporated herein by reference.

### FEDERALLY SPONSORED RESEARCH OR DEVELOPMENT

Not Applicable. Reference to a “Microfiche appendix.”

Not Applicable.

### BACKGROUND

Description of Related Art

Website embodiments supplement methods of producing a calendar containing advertisements by suppliers and distributors, both of which are members of a limited constituency. The calendars are for the use of customers of the distributors, who typically are retailers. The advertisements of the suppliers feature customized product information and promotional offerings of the suppliers who are identified only by identification symbols such as numbers. The advertisements of the distributors, who distribute items manufactured by the suppliers, feature accessible information allowing contact with the distributors and may include promotional offers. The distributors provide their customers, typically retailers, with the calendars and take orders for items listed by the advertisers and others.

The websites of embodiments also provide customized product information on suppliers' products and may include promotional offers and coupons. The websites are readily accessible by the retailer or end-user or any person with access to a website. The suppliers whose products are features are identified only by identification symbols such as numbers. Alternatively, if accessible information on suppliers is included, as statement that the supplier will sell only through distributors also will be included. Accessible information allowing contact with the distributors as well as distributor advertisements and promotional offers which may include coupons for the customizable products are incorporated in the websites.

U.S. Pub. Pat. Applic. 2001/0034670 discloses a system in which the customer contacts and provides information on a purchase and payment to a facilitator who sends information and payment to a manufacturer who sent the product directly to the customer. The facilitator informs the local retailer of the transaction and the manufacturer pays a fee to the local retailer.

U.S. Pub. Pat. Applic. 2001/0049634 discloses a steel industry system in which buyers and sellers have identifying numbers. The buyer enters product specifications and buys products directly from those sellers which are capable of supply such products. The sellers identify qualified buyers through the identifying number.

U.S. Pub. Pat. Applic. 2002/0091565 discloses a system for controlling agent websites. A website with ads for promoted websites is controlled by an agent website which controls the content of the advertising website.

U.S. Pub. Pat. Applic. 2002/0123926 discloses a loyalty program in which both on-line and off-line transactions between customers and clients are recorded and rewards to customers awarded and redeemed.

U.S. Pub. Pat. Applic. 2003/0050958 discloses a system which a customer who deals directly with a supplier can determine the status of an on-line or off-line transaction online.

U.S. Pub. Pat. Applic. 2003/0149635 discloses a system in which a customer for customized products can order directly from a supplier on-line.

U.S. Pub. Pat. Applic. 2003/0167222 discloses a system for distributing complex consumer products. A portal website displays information of several dealerships and several inventory suppliers. The customer accesses the site and orders merchandise from a virtual inventory database and buys the products from the nearest distributor based on the customer's zip code.

U.S. Pat. No. 6,594,641 discloses a system allowing customer to buy boutique or specialty items directly from suppliers or wholesalers. The products are shipped directly to the customers at the retail price and the supplier credits local retailers for some of the lost profits. The retailer to receive the credit is chosen by the customer or by the geographic location of the customer.

Daily Calendars Go Virtual with E-Mail Calendars [online], [retrieved on 2005-03-21]. Retrieved from the Internet <URL: www.emailcalendars.com>, discloses e-mail calendars having specific themes, with photographs, graphics, and editorial, trivia, facts, quizzes and puzzlers, as well as links to sites related to the theme of the calendar.

Your source for Promotional Product Specials, Closeouts, and Coupons [online], [retrieved on 2005-02-28]. Retrieved from the Internet<URL: www.PromotionCorner.com>, discloses coupons bearing the sponsor's name which, when clicked on, links the viewer to the sponsor's website.

Free Virtual Product Sampling on PMDM.com [online], [retrieved on 2005-03-07]. Retrieved from the Internet <URL: www.PromotionCorner.com>, discloses a website wherein an end-user's logo or text can be added to an image of a promotional product, and the image sent by e-mail to the end user by a distributor.

Adlib Specialties [online], [retrieved on 2005-03-21]. Retrieved from the Internet <URL: www.adlibspecialities.com>, discloses a website wherein supplier catalogs for promotional products can be viewed. The buyer then orders customized products from Adlib Specialties who then submits the order to a supplier.

Blastmasters [online], [retrieved on 2005-03-07]. Retrieved from the Internet <URL: www.sales@blastmasters.net>, discloses e-mail which describes closeouts & specials which may be ordered through the suppliers' websites.

Pacific West Marketing [online], [retrieved on 2005-03-22]. Retrieved from the Internet<URL: www. Pacificwestmarketing.com>, discloses a website which provides listing and images of promotional products which may be ordered through Pacific West Marketing. No information leading to identification of the suppliers of the products is provided.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

Exemplary embodiments are methods of purchasing and selling customized promotional products electronically which comprise the following steps. A customer for customized promotional products accesses a customer friendly Internet website. The website includes links to a customer-friendly supplier website or page, the website or page free of accessible information concerning the supplier. Optionally, if the supplier website or page contains accessible information concerning the supplier, the page and website also contains a statement to the effect that the supplier will take orders from and sell only through distributors, and not take orders from or sell directly to customers or end users. The customer orders customized promotional products for use from a distributor whose accessible information is on the customer-friendly website. The customer transmits to the distributor a first set of funds for payment for the products. The distributor forwards the order to the supplier. The distributor transmits a second set of funds for payment for the customizable products to the supplier. The supplier customizes the promotional products with information provided by the customer to the distributor. The supplier transmits the customized products to the customer.

Other embodiments of this invention are websites which consist of pages on the Internet. These include a page with advertisements for customizable promotional products manufactured or customized by a supplier. Also included is a page with an advertisement of a distributor for services provided by the distributor in obtaining custom promotional products from a supplier for a customer. The supplier and distributor are both members of a restricted constituency, and the customer is not a member of the restricted constituency. The pages contain accessible information which allows contact between the distributor and customer. The pages do not contain accessible information which allows contact between the supplier and the customer. The pages identify the supplier only by an identifying symbol which allows the distributor to identify the supplier. Alternatively, if the supplier pages contain accessible information on the supplier, the pages also include a statement to the effect that the supplier will accept orders from, and sell to, only distributors.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a flow chart showing the steps in selling and purchasing customized promotional products electronically in embodiments.

FIG. 2 is a flow chart showing the use of a coupon on the website.

FIG. 3 is a flow chart showing e-mail communication between distributor and customer.

FIG. 4A is a diagrammatic depiction of a website homepage.

FIG. 4B is a diagrammatic depiction of a supplier's page.

FIG. 4C is a diagrammatic depiction of a supplier's detailed product page.

FIG. 4D is a diagrammatic depiction of a coupon page.

FIG. 4E is a diagrammatic depiction of an image page.

FIG. 4F is a diagrammatic depiction of a business advice page.

FIG. 4G is a diagrammatic depiction of a video page.

FIG. 4H is a diagrammatic depiction of a business planner page.

FIG. 4I is a diagrammatic depiction of an order form page.

### DETAILED DESCRIPTION OF THE EMBODIMENTS

In this application the term “restricted constituency” means an organization restricted to suppliers and distributors in a single industry. “Accessible information” means information used by a consumer or customer to identify and communicate with a seller, such as business name, address, telephone number, website address, and e-mail address. “Identifying symbols” means symbols such as numbers and list names or pseudonyms used by members of a restricted constituency to identify each other but which are not generally known by the general public, or customers of members of the restricted constituency. “Promotional offers” means coupons or certificates which offer reduced prices or additional items to the end user making a purchase. Promotional offers may be offered by suppliers or by distributors. “Promotional specialty items” means useful items such as pens, letter openers, balloons, etc. which are customized with the customer's identification information, such as name, logo, address, telephone, fax, and e-mail numbers, and website addresses. The term “supplier” is used to designate a manufacturer or wholesaler who customizes the promotional specialty items. The term “distributor” means a person or organization who accepts orders from customers along with the customized identification material to be placed on the promotional specialty items, transmits the order to the supplier, and provides the customer with the customized promotional specialty items. The term “customer” or “retail customer” means the person or organization who desires promotional specialty items customized with the customer's identification information, such as name, logo, address, telephone, fax, and e-mail numbers, and website addresses. Customer's, who often have retail or service organizations, typically distribute the customized promotional specialty items gratis or as nominal cost to the customer's patrons, termed “users” in this patent application.

The term “website” means a virtual location on the World Wide Web with a unique address and made up of a home page and linked pages. The term “customer-friendly” refers to a supplier website or page which is free of accessible information concerning the supplier or, if accessible information is present, the website or page bears a statement that the supplier will accept orders only from distributors. The term “Internet” means a worldwide computer network. The term “e-mail” means a message send from one person to another via an electronic computer network.

Some examples of limited constituency organizations include the Advertising Specialty Institute (ASI) and the Promotional Products Association International (PPAI). Quick Technologies Inc., Dallas Tex., owns a proprietary limited constituency association.

Limited constituency organizations will be further described using ASI as an example. ASI members are suppliers and distributors of promotional specialty items. Promotional specialty items are typically are custom imprinted with accessible information about the retailer. Promotional specialty items typically are distributed by a retailer to a customer on a free or nominal cost basis. Suppliers manufacture or obtain the promotional specialty items and imprint the items with the retailer's accessible information. The distributors deal with the retailers in obtaining orders for the items, providing the supplier with the accessible information for imprinting on the items, and distributing the items to the retailers.

Each member of a limited constituency is assigned a unique identifying symbol. The symbol does not contain accessible information, but may be used by members of the limited constituency to obtain accessible information about the assignee of the identifying symbol. The use of numbers as identifying symbols is termed a Registered numbering system. Pseudonyms used as identifying symbols are termed line names. Each member of ASI is assigned a unique number termed an ASI number.

Members of the limited constituency such as ASI are free to buy and sell to anyone. In fact, one of the requirements for membership in ASI of a nonmember distributor is demonstration of a number of invoices showing purchases from ASI member suppliers. This demonstrates that the candidate member distributor is a bona fide active distributor in the promotional specialty product industry.

In promotional and advertising material authorized by or sponsored by a limited constituency, and typically supplied to a retail customer by a distributor, the suppliers are identified only by identifying symbol. The distributor is identified by accessible information. This insures that a customer will process his or her order through the distributor rather than dealing directly with the supplier for the promotional specialty items.

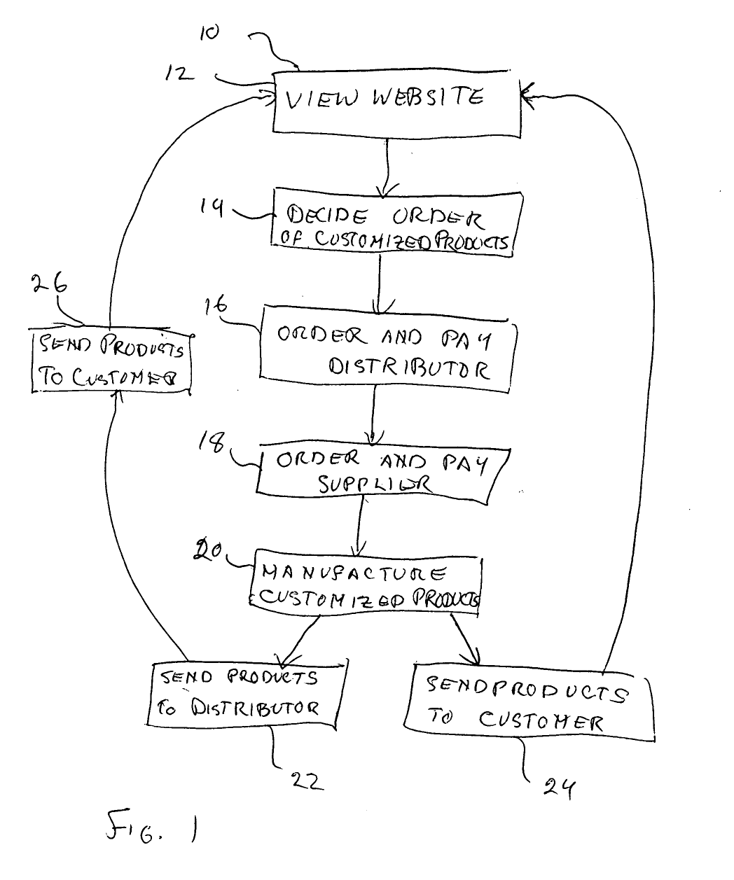

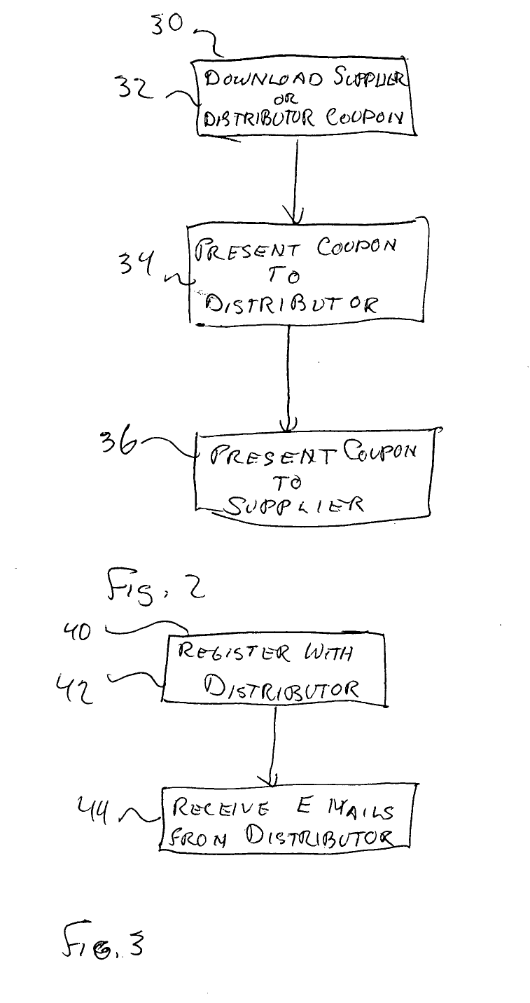

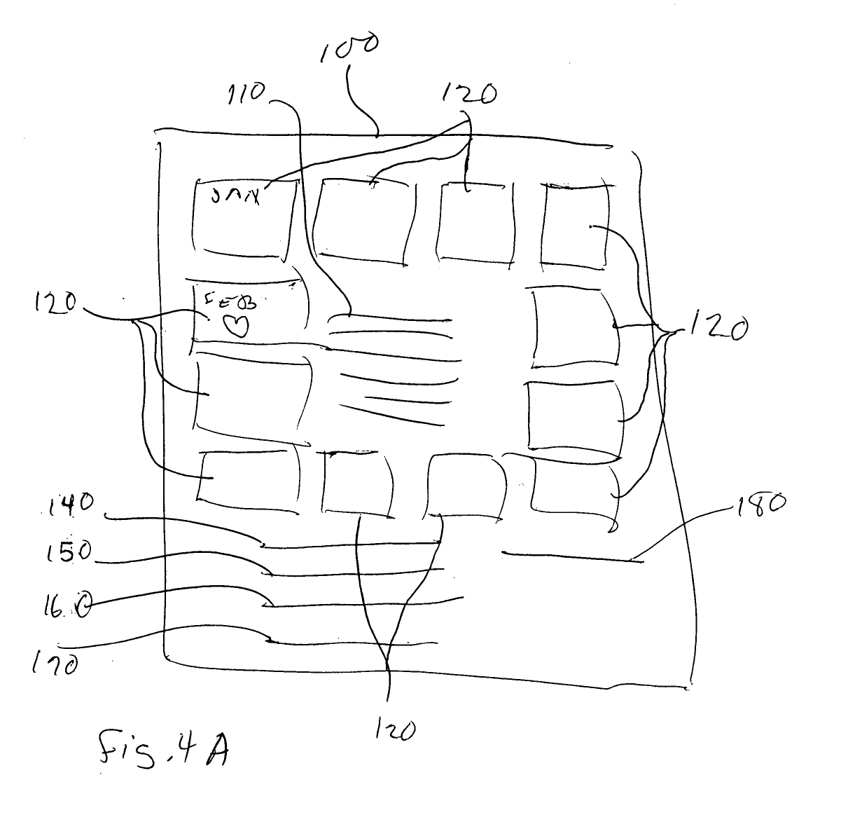

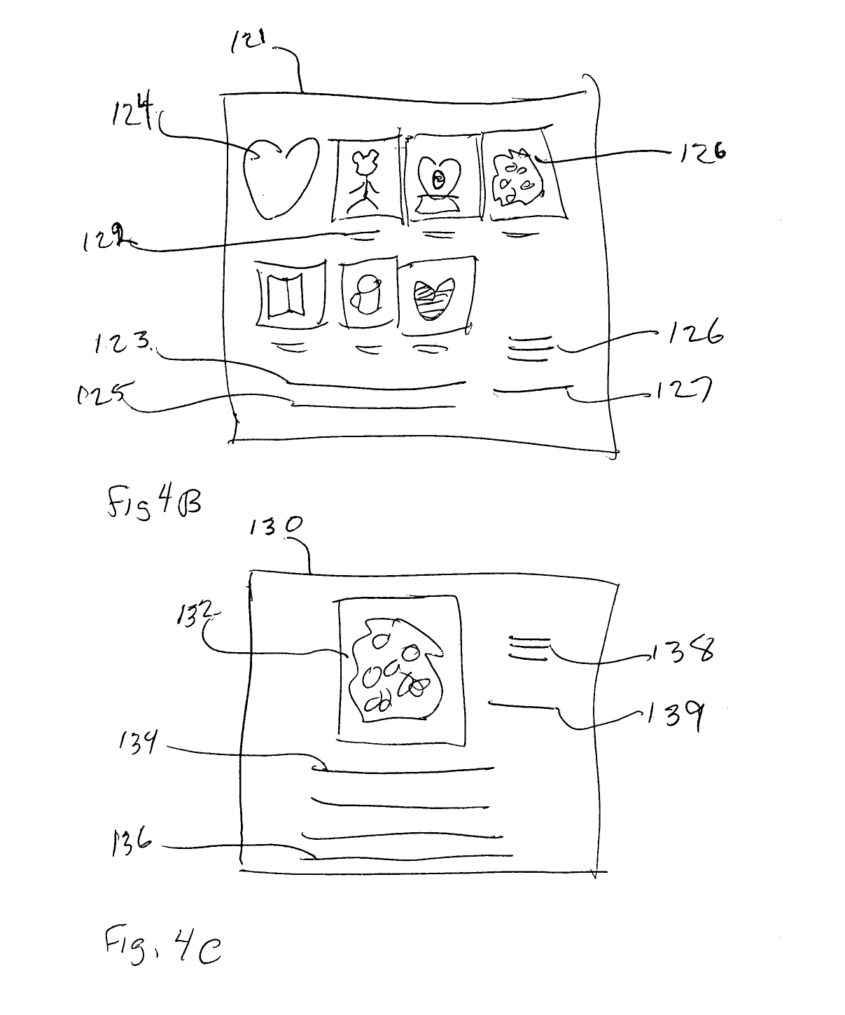

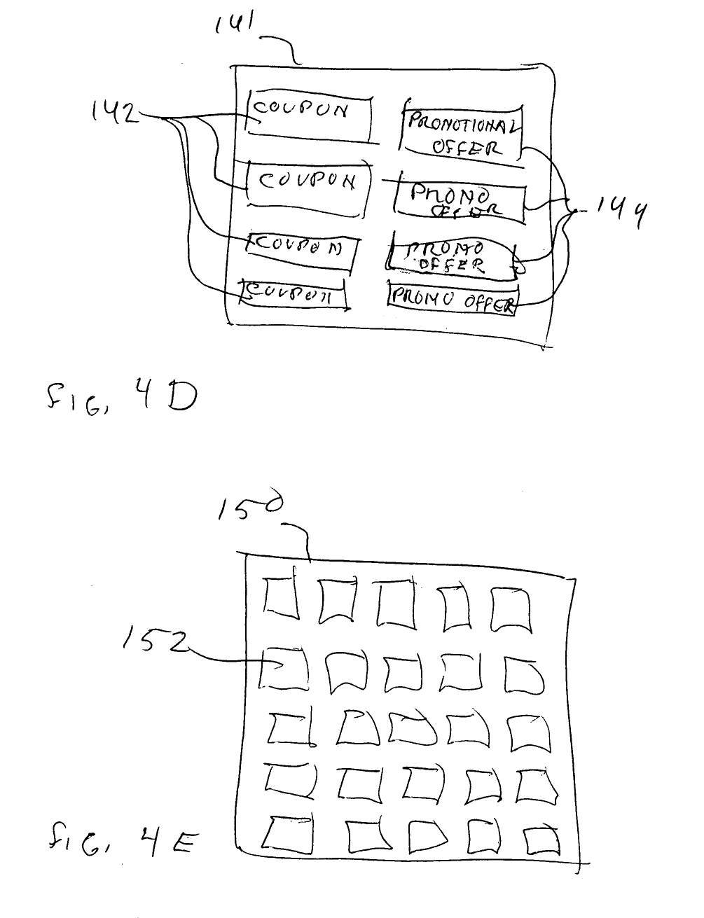

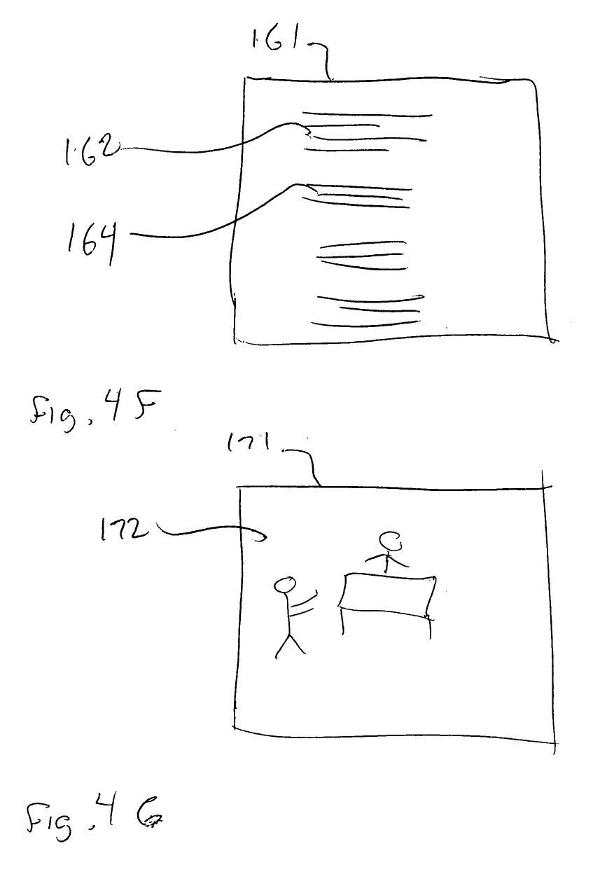

FIG. 1 is a flow chart 10 showing one embodiment, the steps in selling and purchasing customized promotional products electronically via a customer-friendly website. The process starts when a customer views 12 a distributor's website. The customer may learn of the website through a calendar or other means, such as a browser. Access to the website optionally is through entry by the customer of a password which may be listed on the calendar. The distributor's website contains accessible information such as address, e-mail address, telephone and fax numbers which allow the customer to contact the distributor.

The distributor's website contains a variety of links including links to one or more suppliers' page. The suppliers' pages contain information concerning the supplier's customizable promotion products in this embodiment. No accessible information concerning the suppliers is included but an identification symbol for each supplier is included on that supplier's page. Alternatively, if accessible information is included on the supplier's pages, a statement that the supplier will sell only through distributors also is included.

The customer uses the information concerning products, prices, and terms on the supplier's page to develop his or her order 14 of customized products.

The customer uses the accessible information concerning the distributor and the identification symbol from the supplier page to contact the distributor and order and arrange payment 16 for the order of customized promotional products. The order may include the use of coupons and other promotional offers from the supplier's page or distributor's page which will reduce the cost or improve the terms of the purchase for the customer. The order may be submitted using an order form page as depicted in FIG. 41.

The distributor uses the supplier identifying symbol and contacts the supplier and conveys the order for the customized promotional products of behalf of the customer and arranges to pay the supplier for the order 18.

The supplier manufactures or customizes the promotional products as ordered 20.

The supplier then ships the completed customized promotional products to the customer 24. Optionally, the supplier ships the completed order to the distributor 22. The distributor then ships the products to the customer 26.

FIG. 2 is a flow chart 30 showing the use of a coupon or other promotional offer on the website of FIG. 1. The customer observes and downloads 32 a printable coupon or other promotional offer from a supplier or distributor page. The customer then presents the coupon or other promotional offer to the distributor 34 on ordering the product from the distributor. In the case when the coupon or other promotional offer is from the supplier's page, the distributor presents the coupon 36 to the supplier when placing the order with the supplier.

FIG. 3 is a flow chart showing e-mail communication between distributor and customer 40. The customer who is interested in receiving further communications with the distributor registers his or her e-mail address with the distributor 42. The distributor then sends various e-mail communications 44, such as promotional offers, sales, and announcements of new products, to that customer.

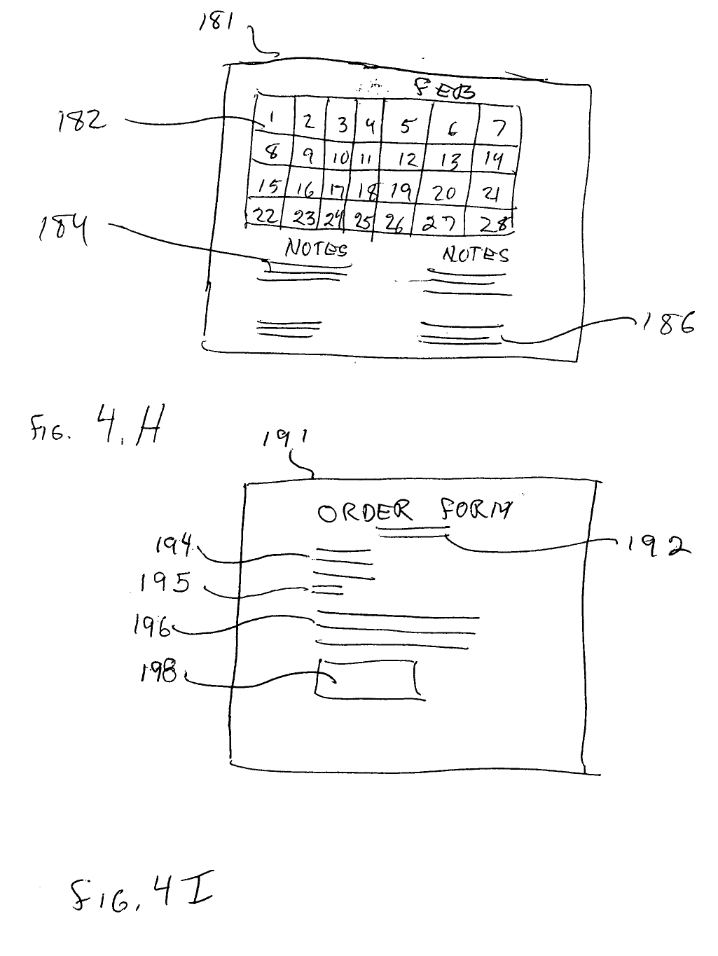

FIG. 4A is a diagrammatic depiction of one embodiment of a distributor's customer-friendly website homepage 100. Accessible information 110 concerning the distributor is prominently displayed on the page. Such information includes the distributor's name, address, telephone and fax numbers, and website and e-mail addresses. An array of boxes 120 each representing one calendar month is on the page. Each box includes a symbol or name of the theme of a promotional program for the month. For example, February 120 may have the theme of appreciation of customers and may be represented by a heart. Additional detail on the subject of monthly themes is in related applications incorporated herein by reference. Link 140 leads to a coupon page described in more detail in FIG. 4D.

Link 150 leads to an image page described in more detail in FIG. 4E. Link 160 leads to a business information page described in more detail in FIG. 4F. Link 170 leads to a video which provides information on the promotional products offered by the distributor and on the best methods for using such products in furthering the customer's business. Link 180 leads to a business planning page described in more detail in FIG. 4H.

FIG. 4B is a diagrammatic depiction of a supplier's page. Selecting a specific box, such as February 120 on the distributor's page, links to a supplier's page 121 which presents the products of the supplier who sponsored the February box. A symbol of the theme 124 is featured on the supplier's page. Also featured are thumbnail images, for example 126, of chocolates, of customizable products provided by that particular supplier. Addition information 122, for example, names, prices and terms for the products, are listed under the thumbnail images. Links to other customer-beneficial offers, such as coupons or other promotional offers 123 may be included on the supplier's page. An identifying symbol which allows the distributor to identify the supplier is also included 125. If accessible information on the supplier 126 is included, a statement 127 that the supplier will sell only through distributors also is included.

FIG. 4C is a diagrammatic depiction of another supplier's page, a detailed product page 130. Selecting a thumbnail image 126 on the supplier's such as depicted in FIG. 4B links to a detailed product page 130. This page includes an enlarged image of the product 132. In some embodiments it may allow the customer to customize the product with the customer's name or other promotional information to provide a realistic impression to the customer of the appearance of the finally customized product. Additional information to aid the customer in making a purchasing decision 134, such as prices and terms, suggestions on customization indicia, and suggestions on promotional programs for use of the customer may be included. An identifying symbol which allows the distributor to identify the supplier is also included 136. If accessible information on the supplier 138 is included, a statement 139 that the supplier will sell only through distributors also is included.

FIG. 4D is a diagrammatic depiction of a coupon page 141. Visible in FIG. 4D are money off coupons 142 and other promotional offers 144 for favorable terms and conditions for customers' orders. In some embodiments the coupon page is printable and enables the customer to print and cut out coupons and other promotional offers for subsequent presentation to a distributor in order to receive reduced prices, favorable terms of delivery, etc. for the customer's order of customized promotional products.

FIG. 4E is a diagrammatic depiction of an image page which presents thumbnail images 152 of all of the customizable promotional products offered by the distributor. Clicking on one image 152 leads to the appropriate product page as depicted in FIG. 4C.

FIG. 4F is a diagrammatic depiction of a business advice page 161. Timely business tips 162 are provided to assist the customer in maximizing the utility of customizable promotional products offered by the distributors and suppliers. In addition, links 164 are provided to Internet pages and websites not directly related to customizable promotional products such as university, government, library, and public service websites. The business advice page may take the form of a weblog or blog. In that case the page would contain dated entries with a running commentary on developments in the industry and information from suppliers, distributors, end users and other marketing information sources such as consultants, and, of course, present the viewpoint of the distributor who sponsors the website. This page may include comments from end users.

FIG. 4G is a diagrammatic depiction of a streaming video 171 which provides video and audio input to the customer. Such a video 172 demonstrates customizable promotional products offered by the distributor as well as promotional campaigns which may be used to maximize the utility of such products to the development of the customer's business.

FIG. 4H is a diagrammatic depiction of a business planning page 181. A calendar 182 which may comprise enough pages to encompass monthly, yearly, or multiyearly planning cycles is depicted. There is a notes 184 area for notations to be added by the customer in planning his or her promotional campaigns. The customer may interact with a representative of the distributor while using the planning page.

FIG. 4I is a diagrammatic depiction of an order form page 191. This form allows the customer to submit an order to a distributor. It includes accessible information on the distributor 192, name and address of customer 194, payment information concerning customer 195, specific details on the products to be ordered 196, and an area for depiction of the specific customization 198 desired on the products being ordered.

Although embodiments have been described above which link from one page to another, it is anticipated that any of the pages may be linked to any or all of the other pages. It is also anticipated that any of the pages or images thereon may be printed or downloaded or otherwise saved and made accessible by the customer for future use and reference.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

I claim:

1. A method of selling and purchasing customized promotional products electronically comprising the steps of:
a. accessing an Internet customer-friendly distributor website or page by a customer, the website or page having accessible information concerning a distributor and links to supplier websites,
b. linking to a customer friendly supplier website or page, the website bearing information concerning the supplier's products, the website or page free of accessible information concerning the supplier or bearing a statement that the supplier will accept orders only from distributors,
c. ordering customized promotional products for use by the customer from the distributor whose accessible information is on the distributor website or page,
d. transmitting a first set of funds for payment for the products to the distributor by the customer,
e. forwarding the order to the supplier by the distributor,
f. transmitting a second set of funds for payment for the customizable products to the supplier by the distributor,
g. customizing promotional products by the supplier using the information provided by the customer to the distributor, and
h. transmitting the customized products to the customer.

2. The method of claim 1 wherein the customized products are transmitted to the customer by the supplier.

3. The method of claim 1 wherein the customized products are transmitted to the distributor by the supplier and to the customer by the distributor.

4. The method of claim 1 wherein the website is accessed using an address listed on a calendar or other promotional material of the distributor.

5. The method of claim 1 wherein step a. further comprises use of a password by the customer in accessing the distributor website or page.

6. The method of claim 1 wherein the distributor is geographically proximal to the customer.

7. The method of claim 1 wherein the order is submitted to the distributor using a order form page.

8. The method of claim 1 further comprising the steps between steps b and c:
b1. downloading a promotional offer coupon by the customer from the distributor page or the supplier page and
b2. presenting the coupon to the distributor by the customer,

9. The method of claim 1 further comprising the step after step b:
b3. registering the customer's e-mail address with the distributor,

10. The method of claim 9 further comprising the step:
b4. sending the customer e-mail communications concerning products, upcoming promotions, contests, virtual product samples, coupons, or sale sheets by the distributor,

11. The method of claim 1 wherein at least one page includes photographs of customizable promotional products.

12. The method of claim 1 wherein at least one page is linked to a video presentation.

13. A customer-friendly website consisting of pages on the Internet comprising:
a page with an advertisement for customizable promotional products manufactured or customized by a supplier, and
a page with an advertisement of a distributor for services provided by the distributor in obtaining custom promotional products from a supplier for a retail customer,
wherein the supplier and distributor are both members of a restricted constituency, and the customer is not a member of the restricted constituency,
the pages contain accessible information which allows contact between the distributor and customer, and
the pages do not contain accessible information which allows contact between the supplier and the customer and the pages identify the supplier only by an identifying symbol which allows the distributor to identify the supplier or, if the pages contain accessible information, the pages bear a statement that the supplier will accept orders only from distributors.

14. The website of claim 13 further comprising a product planner page.

15. The website of claim 13 further comprising a page with a printable coupon.

16. The website of claim 13 further comprising a business advice page.

17. The website of claim 13 wherein at least one page has a photograph of a customizable promotional product.

18. The website of claim 13 wherein at least one page is linked to a video presentation.
